(19) United States
(12) Patent Application Publication
(10) Pub. No.: US 2010/0139689 A1
(43) Pub. Date: Jun. 10, 2010

(54) Electrically powered dental flossing device with sanitary and disposable floss containing unit

(76) Inventor: Victor Couch, Palm Bay, FL (US)

Correspondence Address: ROBERT M. DOWNEY, P.A., 6751 N. FEDERAL HWY., SUITE 300, BOCA RATON, FL, 33487, US

(21) Appl. No.: 12/315,889

(22) Filed: Dec. 8, 2008

(51) Int. Cl. A61C 15/04

(52) U.S. Cl. 132/322; 132/325

(57) ABSTRACT

A device for flossing teeth includes a base unit defining a handle and a disposable head unit that removeably attaches to a top end of the base unit. An electric motor in the base unit, powered by a rechargeable battery, rotates a shaft upon operation of a switch. A pair of hollow tubular arm members extend from a top of the head unit and terminate at opposing open distal ends to define a gap therebetween. A predetermined length of dental floss is partially wound on a first wheel within a clean floss chamber of the head unit and extends through the arm members and across the gap without contacting the distal ends, thereby preventing the transfer of plaque, food particles and bacteria onto exposed surfaces of the arm members. Used floss is wound onto a second floss wheel in a segregated floss collection chamber. The shaft drivingly engages a gear assembly within the head unit for rotating the first and second floss wheels, thereby controlling advanced movement of the floss in order to provide clean floss across the gap, while isolating contaminated floss within the segregated floss collection chamber.

### BACKGROUND OF THE INVENTION

1. Field of the Invention

The present invention relates to flossing devices and, more particularly, to motor driven flossing devices that move dental floss from a clean spool to a collecting spool after use.

2. Discussion of the Related Art

For over one hundred years, people have been using dental floss to remove food and dental plaque from areas between adjacent teeth. Originally made from silk fibers, most dental floss products are now formed by a bundle of thin nylon filaments or a plastic (i.e., Teflon or polyethylene) ribbon. As part of a proper oral hygiene regimen, the American Dental Association advices people to floss once or more per day after brushing their teeth.

The original flossing technique, and one that is still practiced by many people who floss regularly, uses both hands to manipulate a length of dental floss between the teeth. More specifically, the traditional technique for flossing requires that a length of approximately 12-18 inches of floss be pulled and severed from a small plastic dispenser that contains about 100 ft of floss on a spool. The cut length of floss is then wrapped around each of the left and right middle fingers so that a segment of approximately 5 inches spans between the fingers. The index fingers and thumbs of both hands are then used to guide and urge the segment of floss between two adjacent teeth. Then, with the fingers of both hands still in one's mouth, the floss is rubbed against the tooth surfaces from under the gumline up to the top of each tooth. The segment of floss, now carrying plaque and food particles, must be replaced with a clean segment of floss. This is done by winding more floss onto one of the middle fingers, while unwinding floss from the opposite middle finger. This sequence is repeated for all adjacent teeth.

While the above described flossing technique is widely practiced, it presents a number of significant problems and concerns. In particular, placing the fingers of both hands in the mouth is awkward and can be unsanitary. Additionally, it can be difficult to grasp the floss due to the tension that is required in order to push the floss between adjacent teeth. Moreover, the ability to grasp the floss is lessened as the fingers and floss become wet from saliva. And, wrapping the floss around the fingers to maintain a better grasp can cause pain and discomfort. With the floss wrapped tightly on the fingers, it acts as a tourniquet that reduces circulation. Finally, segments of floss that become contaminated with plaque and food particles are wrapped around one of the middle fingers and reinserted into the mouth.

In order to overcome many of the problems mentioned above in connection with manual flossing with a cut length of dental floss, various flossing devices have been proposed in the related art. Many of these devices provide a fork arrangement that holds a segment of floss taut between a pair of spaced apart fork members. A number of flossing devices of this type allow for advancing clean dental floss across the span between the fork members, with the used floss being collected onto a spool. The U.S. patent to Bushman, U.S. Pat. No. 5,613,508 discloses a dental flossing device of this nature, wherein floss is advanced by operating a knob with a finger to thereby pull clean floss from one spool while the used floss collects onto a separate spool. Other flossing devices of this type provide a battery operated motor for rotating the supply spool and the collecting spool in the handle of the flossing device in order to advance clean floss as needed. The devices in this category are often referred to as automatic or motor driven dental flossing devices. Examples of automatic dental flossing devices are shown in the following patents: Bushberger, U.S. Pat. No. 5,267,579; Santoro, U.S. Pat. No. 5,217,031; and Mazza, U.S. Pat. No. 5,176,157. While some of these fixed and automatic advancing flossing devices that use a fork arrangement have been shown to be more convenient to the user when compared to the hand flossing technique; they all suffer from the problem of contamination. Specifically, the above mentioned devices cause plaque, food particles, and bacteria to be scraped from the used segment of floss onto one of the fork members as the floss is advanced across the span between the fork members. Additionally, because the collecting spool and the clean spool of floss are positioned in the same chamber, with no segregation, contaminated floss on the collecting spool grows bacteria and cross contaminates the clean floss. Subsequent users of these devices are then exposed to potentially harmful bacteria and germs.

### OBJECTS AND ADVANTAGES OF THE INVENTION

Considering the foregoing, it is a primary object of the present invention to provide a motor driven dental flossing device that advances clean dental floss across the span of two elongate arm members for convenient and effective flossing between adjacent teeth without having to insert one's fingers into their mouth.

It is a further object of the present invention to provide an electrically powered dental flossing device that avoids having to wrap dental floss around one's fingers, thereby avoiding pain and discomfort.

It is still a further object of the present invention to provide an electrically powered dental flossing device that is specifically structured to avoid collection of plaque, food particles and bacteria on exposed surfaces of the device and, particularly, the ends of the arm members where the floss exits and enters the arm members.

It is still a further object of the present invention to provide an electrically powered dental flossing device that is completely sanitary and which provides easily detachable and disposable head units that contain the entire length of dental floss for a complete flossing procedure.

It is still a further object of the present invention to provide an electrically powered dental flossing device that provides for detachable and replaceable disposable head units, thereby allowing multiple members of the same family to use the same base handle portion, while simply attaching a new expendable head unit containing a sufficient amount of dental floss to perform at least one complete flossing process.

It is still a further object of the present invention to provide detachable and replaceable disposable flossing head units and an adapter for attaching the disposable flossing head units to an existing powered motorized handle, such as those used for toothbrushes.

It is still a further object of the present invention to provide an electrically powered dental flossing device that advances clean floss from a supply wheel for use during flossing, and wherein the used floss is collected on a collection wheel, and further wherein the supply wheel containing clean floss is completely isolated from the collection wheel containing used floss, thereby preventing contamination of the clean floss on the supply wheel.

It is still a further object of the present invention to provide an electrically powered dental flossing device as set forth above, and wherein the floss may be made of various materials and tensile strengths including, but not limited to, nylon filament floss and plastic (i.e., Teflon or Polyethylene) ribbon.

It is still a further object of the present invention to provide an electrically powered dental flossing device as set forth above, and wherein the floss may be coated or impregnated with a flavored anti-septic solution, such a mouth wash.

It is yet a further object of the present invention to provide an electrically powered dental flossing device, as described above, and further including a small mirror on the arm members of the device for allowing the user to see the crevice between adjacent teeth while flossing.

It is still a further object of the present invention to provide an electrically powered dental flossing device, as set forth above, and further wherein the device includes means for storing and playing pre-recorded songs while flossing, thereby making the flossing device fun for kids to use and thus promoting regular flossing.

These and other objects and advantages of the present invention are more readily apparent with reference to the detailed description and accompanying drawings.

### SUMMARY OF THE INVENTION

The present invention is directed to a motor driven flossing device that provides clean dental floss from a supply wheel contained in a disposable head unit throughout the flossing process without contaminating the clean floss or the exposed surfaces of the device. The flossing device includes a base unit, defining a handle, and the disposable head unit that removeably attaches to a top end of the base unit. An electric motor and a rechargeable battery are contained within the base unit. A switch on the exterior of the base unit energizes the electric motor to thereby rotate a drive shaft that extends from the top end of the base unit and into a gear chamber of the head unit. A pair of hollow tubular arm members extend from a top of the head unit and terminate at opposing open distal ends to define a gap therebetween. The gap between the distal ends is sufficient to receive adjacent teeth while holding the base unit and manipulating the arm members during the flossing process. A predetermined length of dental floss is partially wound on a supply wheel within a clean floss chamber of the head unit. The floss extends from the supply wheel, through a first one of the arm members, across the gap, and through the opposite arm member. From the opposite arm member, the floss is directed onto a collection wheel within a segregated floss collection chamber inside the head unit. The open distal ends of the arm members, on opposite sides of the gap, are specifically structured to allow the dental floss to extend across the gap, while held taut, without contacting the exposed surfaces of the distal ends. This prevents the transfer of plaque, food particles, and bacteria onto the exposed surfaces of the arm members as the floss is advanced from the supply wheel, through the arm members and onto the collection wheel. The shaft drivingly engages a gear assembly within the gear chamber of the head unit for rotating the supply wheel and the collection wheel. Accordingly, operation of the switch serves to control advanced movement of the floss through the arm members in order to provide clean floss across the gap, while isolating contaminated floss within the segregated floss collection chamber. The flow may be made of different materials and tensile strengths and may also be coated or impregnated with a flavored anti-septic composition such as mouth wash.

In a further embodiment, a shaft is extended through the head unit to rotate a plate having bumps for engaging the proximal ends of the arm members. Rotation of the plate causes rapid engagement and disengagement of the bumps with the proximal ends of the arm members, thereby creating a vibrating motion of the arm members, and particularly the distal ends and floss that extends across the gap. This vibrating motion provides a therapeutic effect while enhancing the plaque removing motion of the floss during the flossing process. The flossing device may further include a small mirror between the arm members to allow the user to see the space between two adjacent teeth while flossing. A further embodiment of the device provides recorded songs for children.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view of a preferred embodiment of the electrically powered flossing device of the present invention;

FIG. 2 is an isolated view of the distal ends of the opposing arm members of the device, taken along the plane indicated by the arrows 2-2 in FIG. 1, and showing the usable section of floss extending across the gap between the distal ends of the arm members;

FIG. 3 is an isolated top plan view of the opposing arm members taken along the plane indicated by the arrows 3-3 in FIG. 1;

FIG. 4 is an isolated side elevational view of the distal end portion of one of the arm members taken along the plane indicated by the arrows 4-4 in FIG. 1;

FIG. 5 is a top plan view of the dental flossing device of FIG. 1 shown in use with the distal ends of the arm members positioned on opposite sides of the teeth and the floss spanning the gap between the arm members inserted between adjacent teeth during the flossing process;

FIG. 6 is a top plan view of the flossing device, shown in partial cross-section showing the rechargeable battery, electric motor, and gear assembly of the device;

FIG. 7 is a side elevational view of the flossing device taken along the plane indicated by the arrows 7-7 in FIG. 6 and illustrating vibrational movement of the arm members during operation of the device;

FIG. 8 is an isolated cross-sectional view taken along the line 8-8 in FIG. 6;

FIG. 9 is an exploded view, shown in partial cross-section, illustrating separation of a disposable head unit from a base handle unit of the device;

FIG. 10 is a top plan view of a top end of the base handle unit taken along the plane indicated by the arrows 10-10 in FIG. 9;

FIG. 11 is a bottom plan view of a bottom end of the disposable head unit taken along the plane indicated by the arrows 11-11 in FIG. 9;

FIG. 12 is a an isolated cross-sectional view taken along the line 12-12 in FIG. 6; and

FIG. 13 is a top plan view of a vibration generating plate taken along the plane indicated as 13-13 in FIG. 12.

Like reference numerals refer to like parts throughout the several views of the drawings.

### DETAILED DESCRIPTION OF THE PREFERRED EMBODIMENT

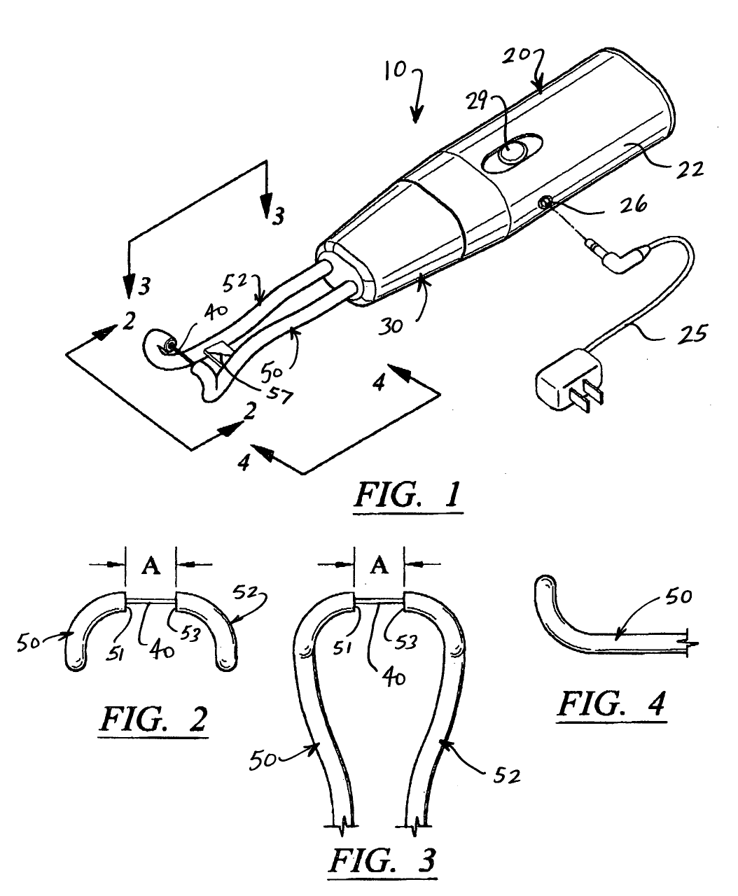

Referring to the several views of the drawings, and initially FIGS. 1-5, the electrically powered dental flossing device is shown and is generally indicated as 10.

The dental flossing device 10 includes a base unit 20 defining a handle and a completely disposable head unit 30 that removeably attaches to the base unit 20. The base handle unit 20 includes a housing 22 that, in a preferred embodiment, is molded from a plastic composition. An electric motor 23 and at least one battery 24 are contained within the base handle unit. The battery 24 may be a replaceable battery, or alternatively, a rechargeable battery. A power cord 25 plugs into a port 26 on the side of the base handle unit and on apposite end plugs into a standard 110 V AC outlet for recharging the battery 24. The battery 24 powers operation of the motor 23 in order to rotate a shaft 28 that extends from the motor 23, out through a top of the base unit 20 and into a gear chamber 34 of the detachable and disposable head unit 30, as described more fully hereinafter. A switch 29 on the exterior of the base handle unit is moveable between an OFF position and an ON position. In a preferred embodiment, there are two ON positions including a forward rotation position and rearward rotation position. The middle position, as shown in FIG. 1, is the OFF position. Moving the switch 29 to the forward rotation on position serves to rotate the shaft 28 of the motor 23 in a direction that will advance clean dental floss 40 across the gap “A” that is defined between the distal ends of two arm members 50, 52. The clean floss 40 is pulled from a clean supply wheel 42 within the disposable head unit 30, and used floss is wound onto a collection wheel 62 that is also within the disposable head unit 30 and segregated from the clean supply wheel 42 of floss 40, as described below. Operation of the switch 29 to the rearward rotation position serves to back the floss 40 across the gap “A” in the opposite direction. This rearward or back motion of the floss may be limited so that contaminated floss does not wind back onto the clean supply wheel 42. Alternatively, the rearward rotation function can be eliminated so that the floss 40 can only advance in one direction from the clean supply wheel 42 to the contaminated collection wheel 62.

The head unit 30 includes a housing 32, also molded of a plastic composition, with interior chambers, including the gear chamber 34, a clean floss chamber 36 and a used floss chamber 38. The pair of arm members 50, 52 extend from a top end of the disposable head unit 30 in opposing relation to one another and terminate at open distal ends 51, 53. The arm members 50, 52 are hollow to allow passage of the floss 40 through the entire length of both arm members. The hollow tubular arm members 50, 52 communicate with the interior floss chambers 36,38 within the disposable head unit 30. Specifically, a first one of the tubular arm members 50 is open at a bottom end 54 to communicate with the interior of the clean floss chamber 36, allowing clean floss 40 from the supply wheel 42 to feed into the bottom open end 54 of the tubular arm member 50 and through the entire length of the first arm member 50 across the gap “A” between the distal ends 51, 53 (without rubbing against the distal ends) and into the opposing arm member 52. The floss 40 is then directed down the second arm member 52, out through an open bottom end 56 into the used floss chamber 38 where it is wound onto the collection wheel 62. The open distal ends 51,53, are specifically structured and configured to avoid rubbing contact with the floss 40, thereby preventing scraping and removal of bacteria from the used floss onto the distal ends of the arm members 50,52 as the floss is advanced or reversed by operation of the motor 23.

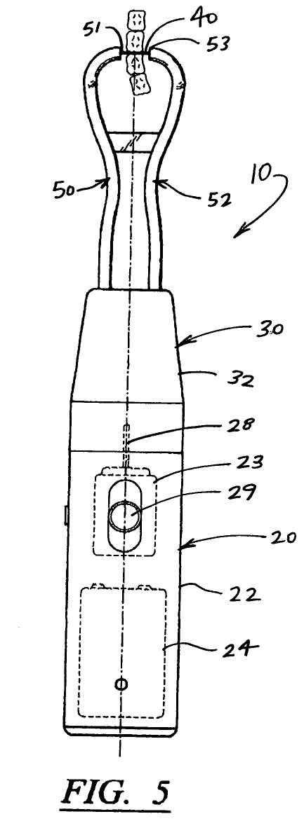

The arm members 50, 52 are preferable curved, as shown in FIGS. 1-4, in order to provide optimal reach and access to all spaces between adjacent teeth within the mouth without difficulty in maneuvering and manipulating the arm members 50, 52 within the mouth. The section of dental floss 40 spanning the gap “A” between the opposing open distal ends 51, 53 of the arm members defines the working section of floss that is moved between adjacent teeth, down into the gum line and then manipulated to remove plaque and food particles from in between the teeth. The gap “A” is sufficiently large to allow passage of the adjacent teeth between the gap “A” as shown in FIG. 5. The disposable head unit may further include a small mirror 57 between the arm members 50, 52 to facilitate viewing of the floss being manipulated between the user's teeth.

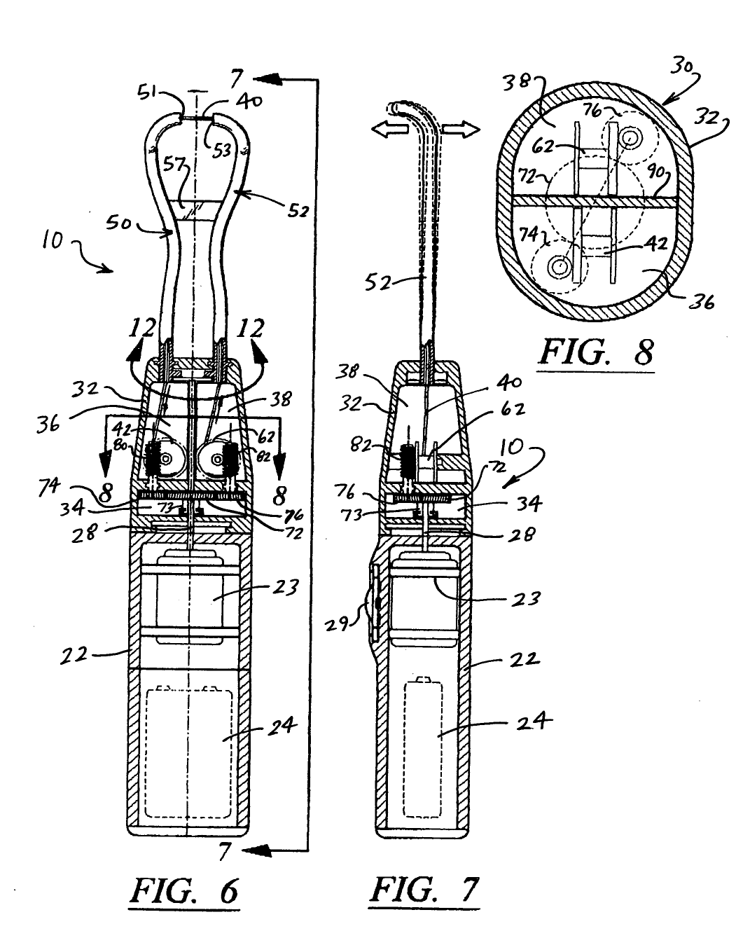

Referring to FIGS. 6-8, the gear chamber 34 in the disposable head unit 30 contains a gear assembly 70 including a main gear 72 and a pair of opposite secondary gears 74, 76 that are drivingly engaged with the main gear 72. The main gear 72 is driven by the motor shaft that is received within a hub on the main gear when the disposable head unit 30 is attached to the base handle unit 20. Upon operation of the motor 23, using the switch 29, the main gear 72 is rotated in a particular direction, thereby driving rotation of the secondary gears 74, 76. The secondary gears 74, 76 are linked to worm gears 80, 82. Specifically, a first one of the secondary gears 76 is linked to a first worm gear 80 that is positioned within the clean floss chamber 36. Similarly, a second of the secondary gears 76 is linked to a second worm gear 82 that is positioned within the used floss chamber 38. The first worm gear 80 is disposed in driven engagement with a gear 84 on the supply wheel 42, whereupon rotation of the main gear 72, first secondary gear 74 and first worm gear 80 serves to rotate the supply wheel 42 in a desired rotational direction to either release floss into the arm member 50 or, alternatively, pull floss back onto the supply wheel 42. In a similar action, the second worm gear 82 is simultaneously driven by the rotation of the main gear 72 and second secondary gear 76 to thereby rotate the collection wheel 62 in the desired direction to either release floss back into the arm member 52 or, alternatively, collect the used floss onto the collection wheel 62.

It is important to note that the clean floss chamber 36 is entirely isolated and separated from the used floss chamber 38 by a dividing wall 90, thereby preventing cross-contamination of clean floss from bacteria on the used floss that is wound onto the collection wheel 62 within the used floss chamber 38. As seen in FIG. 8, the dividing wall 90 extends across the entire with of the interior of the disposable head unit 30 to divide and segregate the clean floss chamber 36 from the used floss chamber 38.

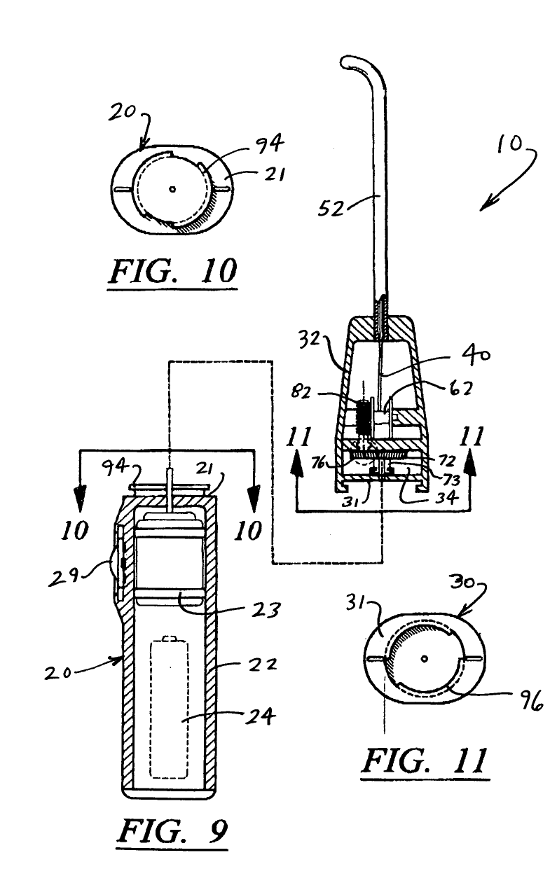

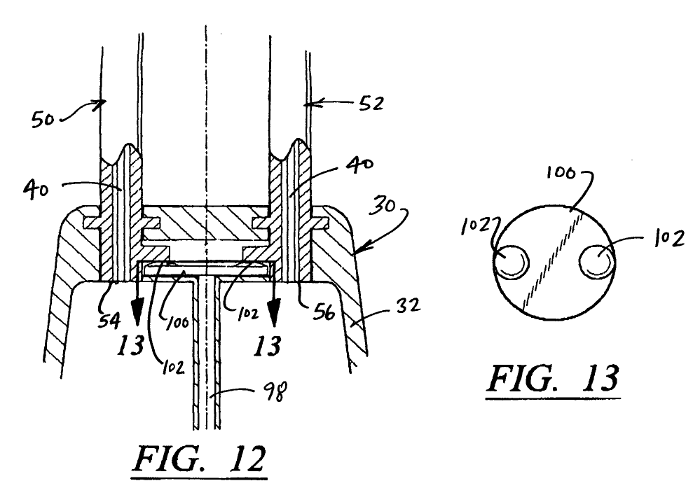

Referring to FIGS. 9-11, the disposable head unit 30 is shown to be removeably attachable to the base handle unit 20. After use during a flossing procedure, the disposable head unit 30 is removed from the base handle unit 20 and is discarded. A new disposable head unit 30 can then be replaced on the base handle unit 20 for the next flossing procedure. To facilitate removable attachment, the top end 21 of the base handle unit 20 and the bottom end 31 of the disposable head unit 30 are provided with cooperating, interlocking structures 94, 96 that allow the head unit 30 to be placed onto the top end 21 of the base handle unit 20 and then, using a partial twisting motion, the cooperating, interlocking structures 94, 96 engage and removeably lock the head unit 30 in operative position on the base handle unit 20. Referring to FIGS. 12 and 13, a further feature of the flossing device is shown for providing vibration of the tubular arm members 50, 52, as depicted by the motion arrows in FIG. 7. More particularly, a secondary shaft 98 extends upwardly through the chambers 36, 38 in the disposable head unit 30 and attaches to a circular plate member 100 positioned above the floss chambers. The circular plate includes a plurality of bumps 102 that engage a portion of the bottom ends 54, 56 of the tubular arm members 50, 52. Upon operation of the motor 23 to rotate the shaft 28, the secondary shaft 38 extending upwardly to the plate causes this plate 100 to rotate, whereupon the bumps 102 rapidly engage and disengage the bottom portions 54, 56 of the arm members, thereby creating a vibrating effect that moves the arm members 50, 52 in a rapid, reciprocating motion as shown in FIG. 7. This vibration action provides a therapeutic effect for massaging the gums, as well as enhancing the removal of plaque and food between adjacent teeth when flossing.

While the invention has been shown and described in accordance with a preferred and practical embodiment thereof, it is recognized that departures from the instant disclosure are fully contemplated with the spirit and scope of the invention, which, therefore, is not to be limited except as defined in the flowing claims as interpreted under the Doctrine of Equivalence.

What is claimed is:

1. A flossing device for use with a handle having an electrically powered motor that spins a shaft, said flossing device comprising:
a head unit including a housing surrounding a gear chamber, a clean floss chamber and a used floss chamber;
a gear assembly within said gear chamber;
said head unit being structured and disposed for removable attachment to the handle with the shaft drivingly engaged with said gear assembly;
a pair of tubular arm members extending from the housing of said head unit and including a first arm member and a second arm member, said first and second arm members terminating at opposing open distal ends to define a gap between, and said first arm member having an open bottom end communicating with said clean floss chamber, and said second arm member having an open bottom end communicating with said used floss chamber;
a first floss wheel rotatably supported within said clean floss chamber;
a second floss wheel rotatably supported within said used floss chamber;
a predetermined length of dental floss wound on said first floss wheel within said clean floss chamber and extending through said open bottom end and through said first arm member, across the gap and through said second arm member, out from the open bottom end of said second arm member and onto said second floss wheel within said used floss chamber, and said opposing distal ends of said arm members being structured and disposed to be normally spaced from the floss extending across the gap to thereby prevent transfer of plaque, food particles and bacteria from the floss and onto said distal ends;
said gear assembly being driven by the spinning of the shaft to rotate at least one of said first and second floss wheels, thereby advancing the floss from the first floss wheel, through the arm members, across the gap and onto the second floss wheel; and
said clean floss chamber being isolated from said used floss chamber to prevent contamination of the clean floss by food, plaque and bacteria that collects in said used floss chamber.

2. The flossing device as recited in claim 1 further comprising:
a dividing wall between said clean floss chamber and said used floss chamber for segregating and isolating said clean floss chamber from said used floss chamber, thereby preventing contamination of the clean floss within said clean floss chamber.

3. The flossing device as recited in claim 1 wherein said gear assembly is structured and disposed to be driven by the shaft in both a forward direction for advancing the floss by removing clean floss from the first floss wheel, and a reverse direction for rewinding the clean floss back onto the clean floss wheel.

4. The flossing device as recited in claim 1 further comprising:
a mirror attached to at least one of said pair of tubular arm members.

5. The flossing device as recited in claim 1 further comprising:
a mechanism within said head unit and driven by the spinning of the shaft for moving said pair of tubular arm members in a vibrating action.

6. The flossing device as recited in claim 1 wherein said pair of tubular arm members are structured and disposed for surrounding and concealing the floss extending therethrough.

7. The flossing device as recited in claim 6 wherein said opposing open distal ends of said pair of tubular arm members are sized and configured to normally avoid contact with the floss extending therethrough and across the gap.
